(19) United States
(12) Patent Application Publication
(10) Pub. No.: US 2026/0105266 A1
(43) Pub. Date: Apr. 16, 2026

(54) SYSTEMS AND METHODS FOR DOCUMENT TRANSLATION

(71) Applicant: ADOBE INC., SAN JOSE, CA (US)

(72) Inventors: Li Sun, San Jose, CA (US); Raghvi Kabra, San Francisco, CA (US); KoUn Eom, Burlingame, CA (US); Tanya Agarwal, Noida, Uttar Pradesh (IN); Anirudh Kumar Singh, Noida, Uttar Pradesh (IN); Arif Ahmad Khan, Noida, Uttar Pradesh (IN); Kenil Vora, Bellevue, WA (US); Akulaa Agarwal, Noida, Uttar Pradesh (IN); Ankush Sharma, Noida, Uttar Pradesh (IN); Raghuveer Singh, Noida, Uttar Pradesh (IN); Jatin Sethi, New Delhi (IN); Lily Wen, San Jose, CA (US); Christina Clark, Berkeley, CA (US); Peter Kwak, San Francisco, CA (US); Richa Gupta, New Delhi (IN); Israel Noto Garcia, San Francisco, CA (US); Karan Khera, Noida, Uttar Pradesh (IN); Vaibhav Sharma, San Jose, CA (US); Achintya Dixit, Noida (IN); Bhavya Bapna, Noida (IN); Kshitij Gupta, Ghaziabad, Uttar Pradesh (IN); Mohit Kumar, Bathinda, Punjab (IN); Sirisha Akula, Jamshedpur (IN); Vivek Verma, Delhi (IN); Mohd Ziaullah, New Delhi (IN); Ashutosh Ranjan Chaturvedi, Ghaziabad, Uttar Pradesh (IN)

(21) Appl. No.: 19/208,070

(22) Filed: May 14, 2025

Related U.S. Application Data
(60) Provisional application No. 63/706,122, filed on Oct. 11, 2024.

(51) Int. Cl. G06F 40/58; G06F 40/106; G06F 40/253

(52) U.S. Cl. CPC G06F 40/58; G06F 40/106; G06F 40/253

(57) ABSTRACT

A method, apparatus, non-transitory computer readable medium, and system for media processing include obtaining an input document including a context element and a text element, where the text element includes text in a source language, generating a prompt based on the context element and the text element, where the prompt comprises a sequence of tokens representing instructions for a language generation model to translate the text into a target language, translating the text into the target language based on the prompt, and generating an output document including the context element and the text element with the translated text.

### CROSS-REFERENCE TO RELATED APPLICATION

This application claims priority under 35 U.S.C. § 119 to U.S. Provisional Application No. 63/706,122, filed on Oct. 11, 2024, in the United States Patent and Trademark Office, the disclosure of which is incorporated by reference herein in its entirety.

### BACKGROUND

The following relates generally to document translation using machine learning. Machine learning algorithms build a model based on sample data, known as training data, to make a prediction or a decision in response to an input without being explicitly programmed to do so.

One area of application for machine learning is natural language generation. For example, machine learning models may be used to generate a natural language output based on an input. Some machine learning models are able to generate a natural language output in one language based on a text input provided in a different language.

### SUMMARY

Systems and methods are described for generating a translated document. In some embodiments, a media processing system identifies pertinent context for text included in a document and uses a language generation model to translate the element given the pertinent context. Because the text is provided to the language generation model with the document context, an ambiguity about the meaning of the text is reduced, allowing the language generation model to make a more accurate prediction of the proper translation of the text into another language. By contrast, conventional machine learning models that are trained to generate translations are not able to receive contextual inputs, and therefore cannot make accurate predictions of proper translations of words whose proper meaning is only discernable given the context that they appear in. Finally, given the media processing system generates an output document by replacing the original text with the translated text.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a media processing system according to aspects of the present disclosure.

FIG. 2 shows an example of a method for translating a document according to aspects of the present disclosure.

FIG. 3 shows an example of a media processing system for generating a document including translated text according to aspects of the present disclosure.

FIG. 4 shows an example of a user interface for generating a document including translated text according to aspects of the present disclosure.

FIG. 5 shows an example of a transformer according to aspects of the present disclosure.

FIG. 6 shows an example of a method for generating a document including translated text according to aspects of the present disclosure.

FIG. 7 shows an example of a method for generating a document including additional translated text according to aspects of the present disclosure.

FIG. 8 shows an example of a method for generating an additional document including text translated in an additional language according to aspects of the present disclosure.

FIG. 9 shows an example of a method for generating multiple documents in multiple languages according to aspects of the present disclosure.

FIG. 10 shows an example of a flow diagram depicting an algorithm as a step-by-step procedure for training a machine learning model according to aspects of the present disclosure.

FIG. 11 shows an example of a computing device according to aspects of the present disclosure.

FIG. 12 shows an example of a media processing apparatus according to aspects of the present disclosure.

### DETAILED DESCRIPTION

### Overview

The following relates to document translation using machine learning. Some conventional translation models are specifically trained to perform language translation using deep learning models. However, conventional translation models are not able to handle context-sensitive translations, and are not able to use a context of a document to translate words of the document that have multiple meanings. For example, without appropriate context from a document, a conventional translation model is unable to know whether a word “bow” appearing in the document refers to, e.g., a ribbon, a forward part of a boat, a projectile weapon, a bodily gesture, buckling, etc.

Accordingly, aspects of the present invention leverage advanced capabilities of a language generation model (e.g., a large language model) to generate a translation of document text from a source language into a target language based on a context from the document. For example, a media processing system according to the present disclosure may determine that a document includes the text “bow” and a picture of a bow and arrow. The media processing system may then instruct a language generation model to translate the word “bow” given the context of the picture of the bow and arrow. Therefore, the media processing system encourages the language generation model to interpret and translate the word “bow” as the noun “bow” that refers to a weapon, rather than a different meaning of “bow”.

Aspects of the present disclosure are therefore able to generate documents including more accurate translations of document text than are provided by conventional translation models. Specifically, the translations of document text have an increased linguistic accuracy and contextual appropriateness over translations provided by conventional translation models, and are therefore more relevant and tailored to specific user needs, such as accurate and efficient communication across languages. Furthermore, the language generation model can adapt to various domains and styles, enhancing a versality of the language generation model.

According to some aspects, the language generation model excels in understanding context, allowing the language generation model to accurately interpret words with more than one meaning. By leveraging contextual clues, the language generation model provides translations that are precise and relevant.

According to some aspects, a method for media processing includes extracting text from a text element (e.g., a text field) of a document, identifying a context from the document, such as a caption of an image thumbnail, a mood, a segment, a style, a title of a page of the document, or a topic of the page, and translating the extracted text using the extracted context. The caption may be generated based on an image (e.g., an image thumbnail) extracted from the document. The mood, segment, style, title, and topic may be included in the document as metadata.

Furthermore, according to some aspects, a user may select one or more text elements of the document across one or more pages of the document for translation and may therefore leave out other text that might not need to be translated, such as names, addresses, dates, URLs, emails, etc. According to some aspects, a user may choose from multiple languages for the translation, allowing for single-click multilingual translation.

### Terminology Examples

A “document” includes any media item that can include a text element. Examples of a document include a word processor file, a spreadsheet, a presentation slide, a Portable Document Format (PDF) file, a website, a smartphone or tablet app, an image file, and the like. An “input document” refers to a document that is input to the media processing system. The input document includes text in the source language. An “output document” refers to a document that is generated by the media processing system. The “output document” includes text translated in a target language.

A “context element” includes an element of a document that provides context for the document (e.g., contributes to an understanding of a meaning of the document). Examples of a context element include an image, metadata, a layout (such as a position of an element within the document), a style (such as a text font), text, or a quantity of text.

A “text element” is a text field or text box of a document. A text element may include text, or a group of one or more text characters. A “language” is a system of grammar and vocabulary that allows text provided according to the language to be understood by a person that understands the system of grammar and vocabulary or a model (such as a machine learning model) that is trained or designed based on the system of grammar and vocabulary. In an example, the text “Ring of Fire” is written in English and is therefore provided according to English. A “source language” is a language that text is originally presented in. A “target language” is a language that text is intended to be translated into.

A “prompt” is an instruction to a language generation model to generate an output based on information included in the prompt. “Translated text” is text that is translated from a source language to a target language.

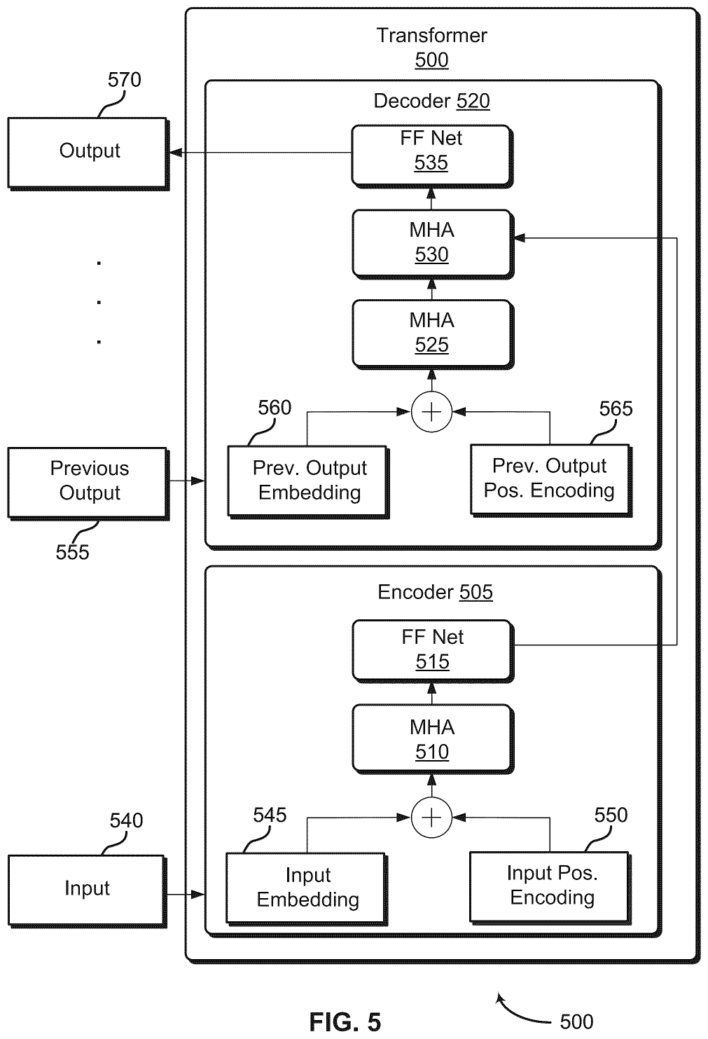

A “language generation model” refers to a machine learning model that is trained to generate a text output based on an input, such as a language model. The language generation model may include one or more transformers, for example, such as the transformer described with reference to FIG. 5. A transformer may comprise an encoder and a decoder. The encoder takes in input data, such as a sentence, and encodes the input into a set of continuous representations or embeddings. The encoder processes the entire input sequence at once, learning relationships between each of the tokens in the sequence. The decoder takes the encoded information as input and generates an output sequence one token at a time. The decoder attends to previous tokens that the decoder has generated, allowing the decoder to make predictions about a next token in a sequence.

According to some aspects, a language generation model comprises a decoder-only language model. A decoder-only language model, such as a generative pretrained transformer, omits an encoder and performs autoregressive text generation by predicting one output token at a time based on an input sequence of text, where each prediction is conditioned on tokens that the model has already generated. After generating the first token, the decoder-only language model adds the first token to the input and predicts a next token, continuing the process. The decoder uses self-attention to attend to previously generated tokens, helping the decoder-only language model to understand relationships between each of the tokens in the sequence, allowing the decoder-only language model to generate coherent and contextually appropriate text.

An example media processing system according to the present disclosure is used in a document translation context. In an example, a user provides a PDF file including a picture of an erupting volcano and the English words “Ring of Fire” to the media processing system, along with an instruction to translate the English words into Hindi. The media processing system uses a language generation model to generate a translation of the words “Ring of Fire” into an equivalent Hindi idiom given the context of the image of the erupting volcano. The media processing system then generates a new PDF file including the image of the erupting volcano and the Hindi translation in a style and position corresponding to the style and position of the English words “Ring of Fire” in the original document.

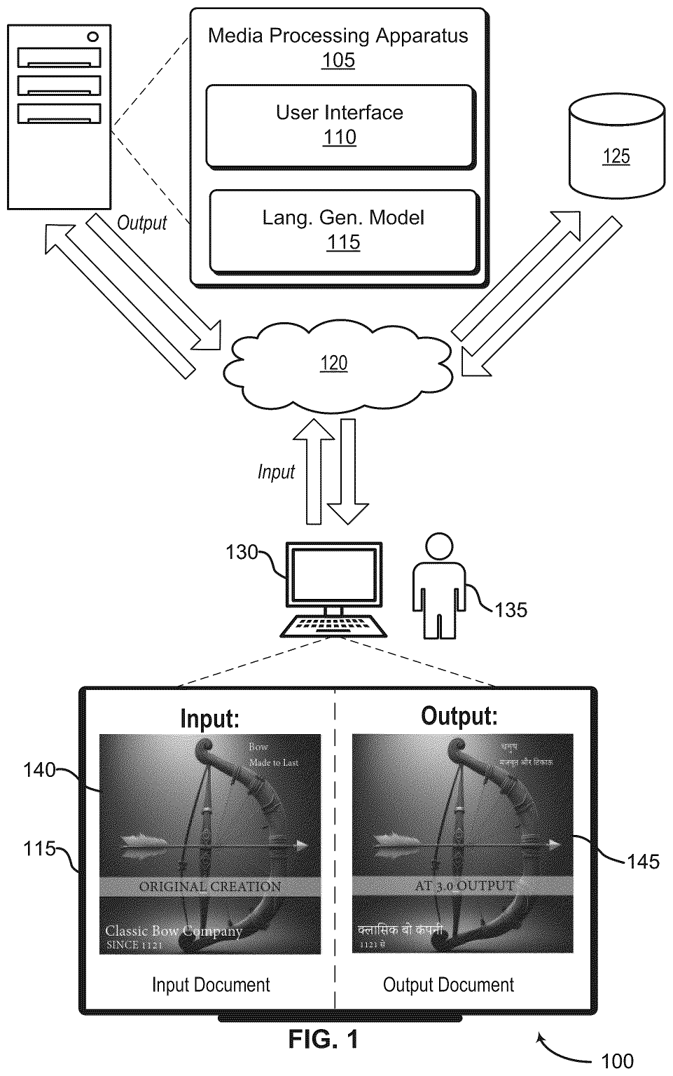

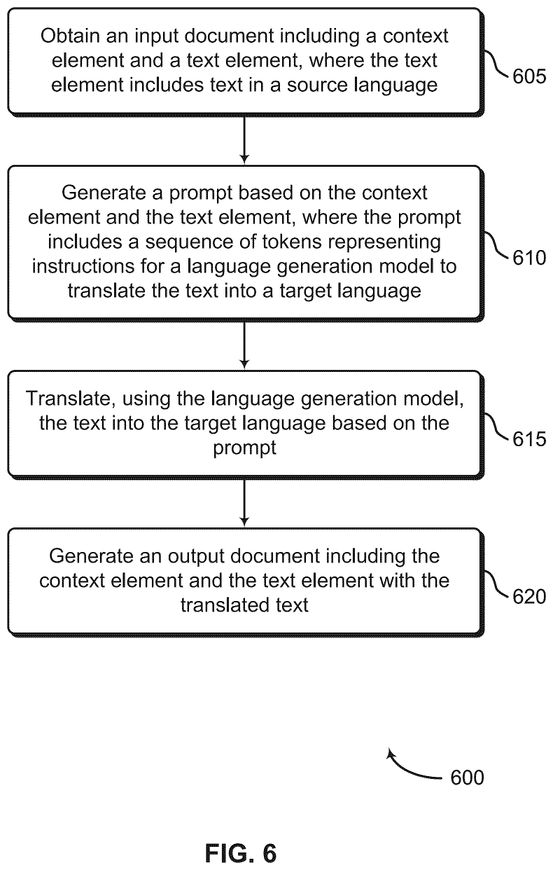

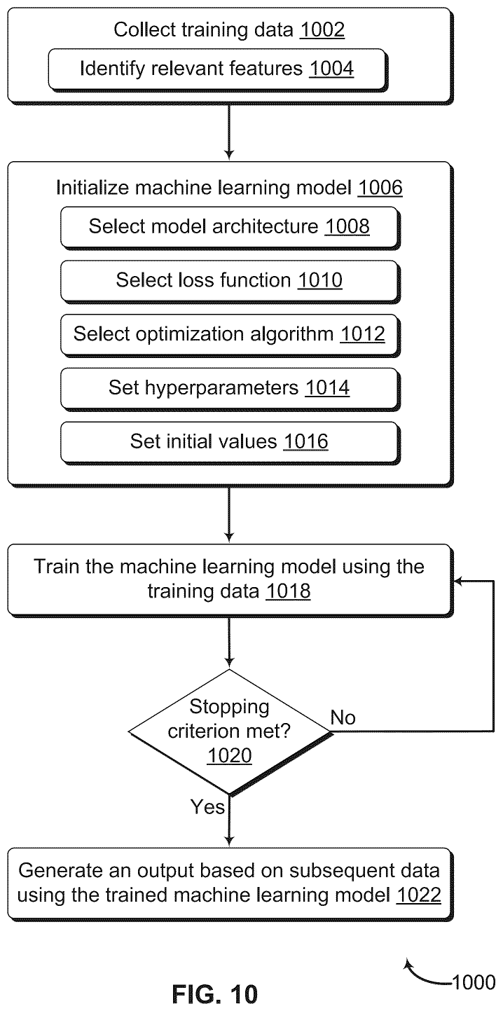

Further example applications of the present disclosure in a document translation context are provided with reference to FIGS. 1-4. Details regarding the architecture of a media processing system are provided with reference to FIGS. 1-5 and 11-12. Examples of a process for generating a document including translated text are provided with reference to FIGS. 6-9. Examples of a process for training a machine learning model is provided with reference to FIG. 10.

Embodiments of the present disclosure improve upon conventional media processing systems by making a text translation process more accurate. For example, some embodiments achieve this accuracy by identifying pertinent context in a document and using a language generation model (e.g., a large language model) to translate text included in the document given the pertinent context. Because the text is provided to the language generation model with the document context, an ambiguity about the meaning of the text is reduced, allowing the language generation model to make a more accurate prediction of the proper translation of the text into another language.

By contrast, conventional machine learning models that are trained to generate translations are not able to receive contextual inputs, and therefore cannot make accurate predictions of proper translations of words whose proper meaning is only discernable given the context that they appear in.

Furthermore, embodiments of the present disclosure provide for a more efficient translation of multiple text items across multiple pages of a document into multiple languages than conventional translation systems provide. For example, some embodiments achieve this efficiency by providing a user interface that accepts a selective identification of the multiple text items and an identification of multiple target languages. The user interface also provides for a single-click generative process based on the selected text items and identified target languages.

### Media Processing System

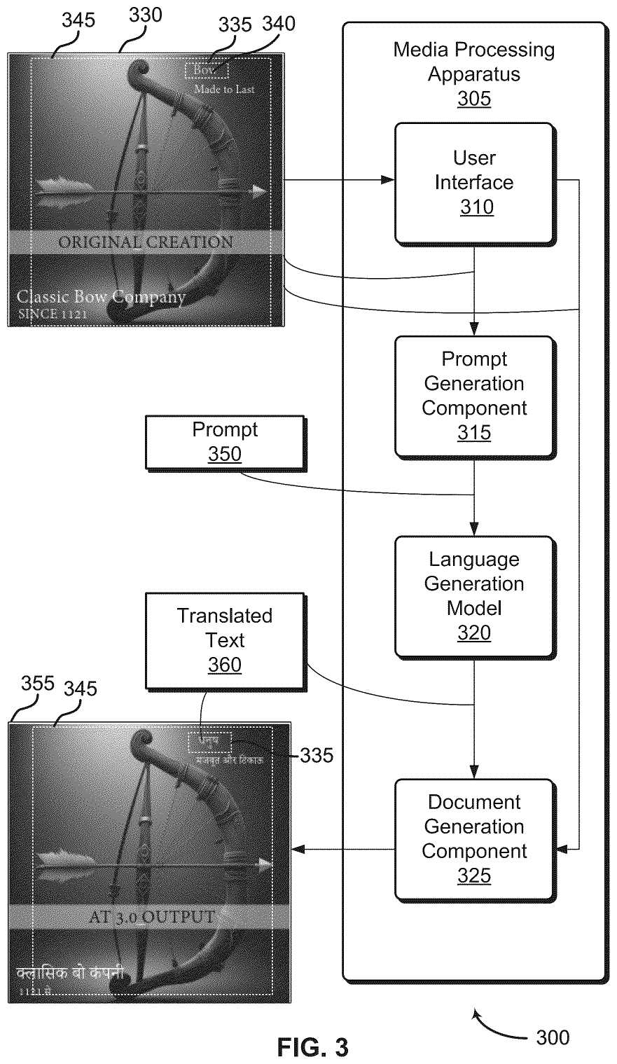

FIG. 1 shows an example of a media processing system 100 according to aspects of the present disclosure. The example shown includes media processing system 100, user device 130, user 135, input document 140, and output document 145. Media processing system 100 is an example of, or includes aspects of, the corresponding element described with reference to FIG. 3. In one aspect, media processing system 100 includes media processing apparatus 105, cloud 120, and database 125. In one aspect, media processing apparatus 105 includes user interface 110 and language generation model 115.

Referring to FIG. 1, media processing apparatus 105 receives an input document (e.g., input document 140) via user interface 110. In an example, a user (e.g., user 135) provides the input document to media processing apparatus 105 via user interface 110 displayed by media processing apparatus 105 on a user device (e.g., user device 130). The input document includes a context element and a text element including text provided according to a source language. In the example of FIG. 1, the context element is an image of a bow and arrow, and the text is the English word “bow”.

Media processing apparatus 105 generates a prompt instructing language generation model 115 to generate a translation of the text into a target language based on the context element. In the example of FIG. 1, media processing apparatus 105 generates a prompt instructing language generation model 115 to generate a translation of the word “bow” into Hindi given the context of the document including an image of a bow and arrow.

Media processing apparatus 105 uses language generation model 115 to generate a text output based on the prompt. In this case, the text output is a translation of the word “bow” into Hindi. Media processing apparatus 105 generates an output document (e.g., output document 145) including the text output. In the example of FIG. 1, output document 145 includes the Hindi translation of the English word “bow” in the text element and having a style corresponding to the style of the English word “bow” in input document 140. Media processing apparatus 105 provides the output document to the user via user interface 110.

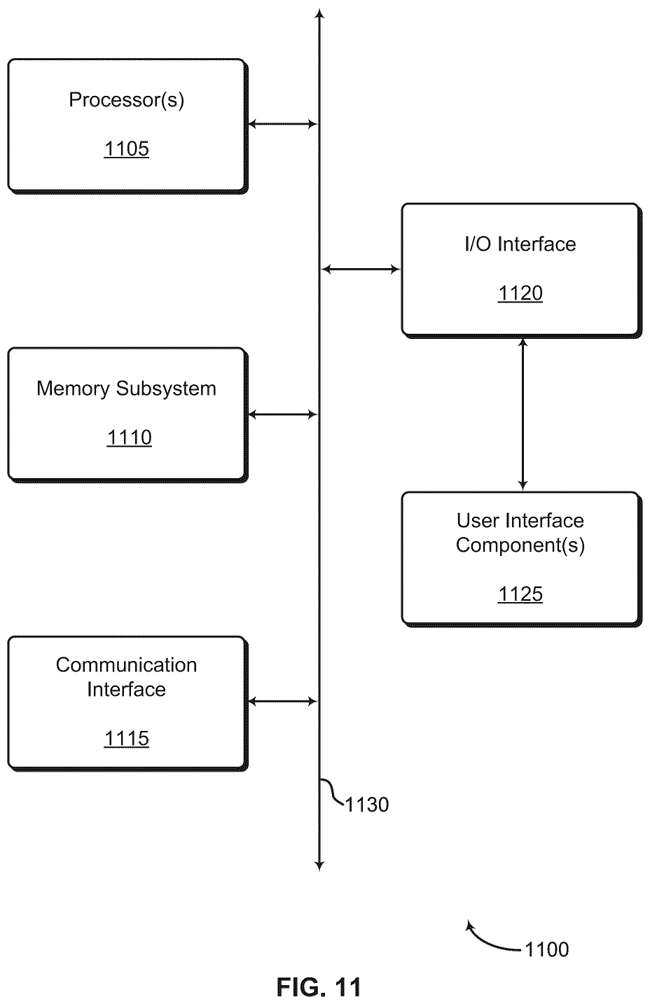

Media processing apparatus 105 is an example of, or includes aspects of, the corresponding element described with reference to FIGS. 3, 11, and 12. According to some aspects, media processing apparatus 105 includes a computer-implemented network. In some embodiments, the computer-implemented network includes a machine learning model (such as language generation model 115, described in further detail with reference to FIGS. 3, 5, and 12). Media processing apparatus 105 may also include one or more processors, a memory subsystem, a communication interface, an I/O interface, one or more user interface components, and a bus as described with reference to FIG. 11. Additionally, media processing apparatus 105 may communicate with user device 130 and database 125 via cloud 120.

According to some aspects, media processing apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

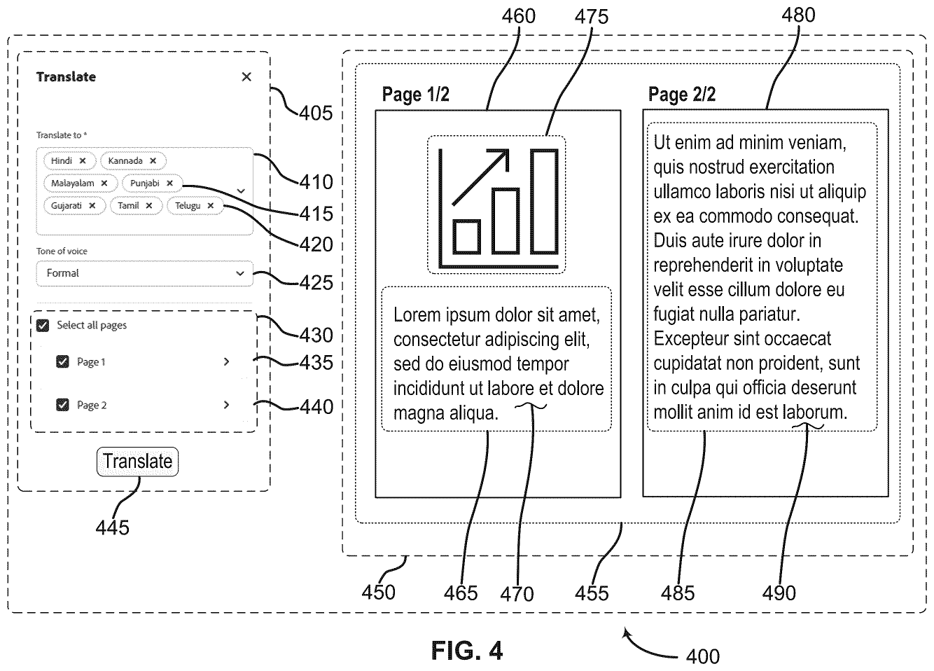

User interface 110 is an example of, or includes aspects of, the corresponding element described with reference to FIGS. 3 and 4. According to some aspects, user interface 110 comprises a text interface, a graphical user interface, or a combination thereof.

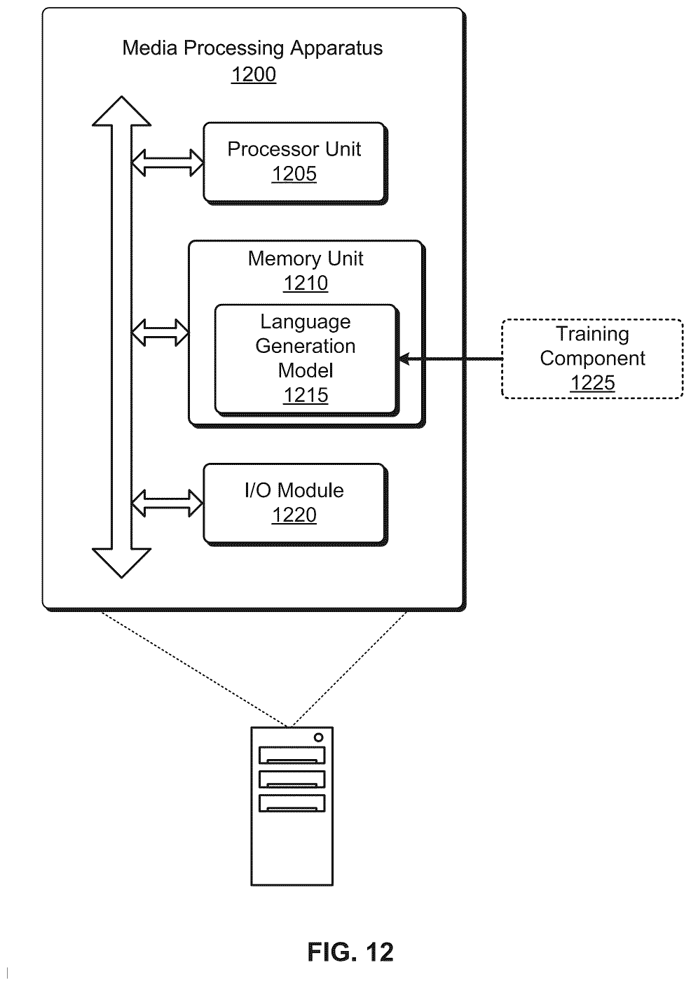

Language generation model 115 is an example of, or includes aspects of, the corresponding element described with reference to FIGS. 3 and 12. According to some aspects, language generation model 115 comprises machine learning parameters stored in a memory unit of media processing apparatus 105 (such as the memory unit 1210 described with reference to FIG. 12).

According to some aspects, language generation model 115 comprises an artificial neural network (ANN) that is able to generate a text output based on a prompt. For example, in some embodiments, language generation model 115 comprises a large language model (LLM). LLMs acquire an ability to perform language processing tasks, including natural language processing tasks, by learning statistical relationships from vast amounts of text during a self-supervised and/or semi-supervised training process.

According to some aspects, language generation model 115 comprises one or more transformers. According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures, particularly ANNs employed in natural language processing (NLP) and sequence-to-sequence tasks, which allows an ANN to focus on different parts of an input sequence when making predictions or generating output. NLP refers to techniques for using computers to interpret or generate natural language. NLP tasks can involve assigning annotation data such as grammatical information to words or phrases within a natural language expression.

Some sequence models process an input sequence sequentially, maintaining an internal hidden state that captures information from previous steps. However, this sequential processing can lead to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function.

The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

According to some aspects, language generation model 115 is trained to generate a prompt embedding representing the prompt in a vector space. An “embedding” refers to a representation of an object (e.g., the natural language query) in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined. A “natural language query embedding” refers to an embedding of the natural language query, e.g., a representation of the natural language query in an embedding space. An “embedding space” (or a “vector space”) refers to a set having embeddings (or vectors) as elements, and is characterized by a dimension specifying a number of independent directions in the embedding space.

In some examples, generating the prompt embedding comprises tokenizing the prompt to obtain a sequence of tokens and computing a vector representing the prompt based on the sequence of tokens. In some examples, the prompt embedding includes the vector.

Tokenization refers to a process for converting a text string input into a sequence of token representations of a word, sub-word, or character. In some examples, tokenizing the natural language query includes cleaning the natural language query by removing any characters, punctuation, or special symbols that do not contribute to the meaning of the natural language query, splitting the natural language query into individual tokens representing words, sub-words, or characters of the natural language query, and adding start-of-sequence and end-of-sequence special tokens to denote the beginning and the end of the token sequence, respectively. Tokenization can include adding padding tokens to the token sequence, or truncating the token sequence, where an attention mask is generated to indicate which tokens are actual words and which ones are padding tokens. Each token in the token sequence is converted to a unique integer identifier based on the embedding model's vocabulary. Finally, the token sequence including the unique integer identifiers is converted by the embedding model into the natural language query embedding in the vector space.

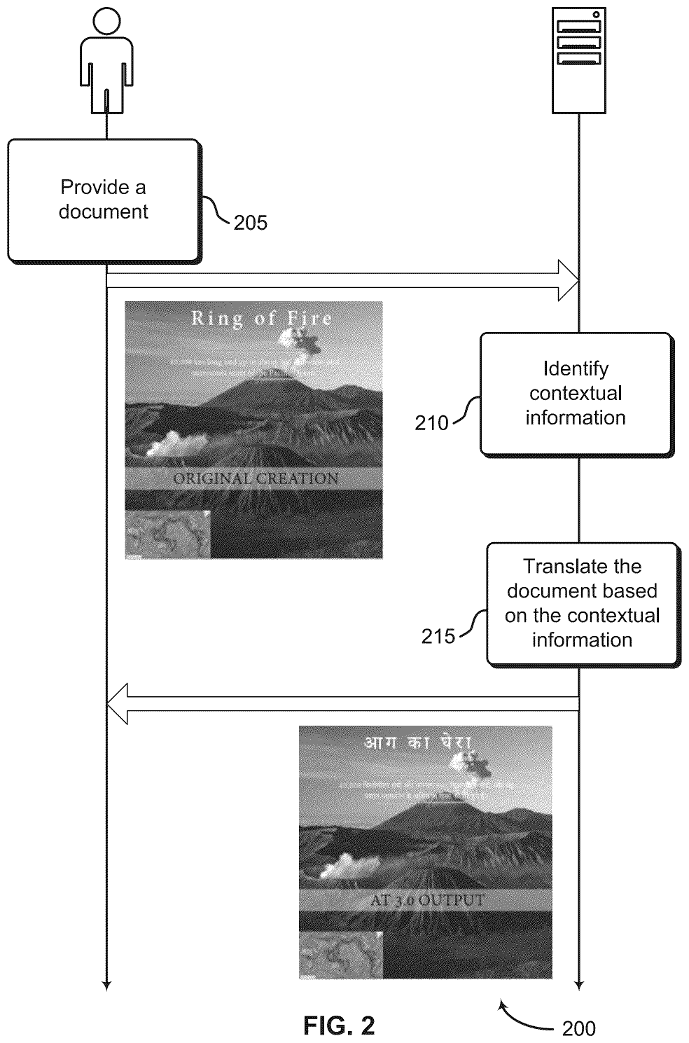

Further detail regarding the architecture of a media processing system are provided with reference to FIGS. 3-5 and 11-12. Further detail regarding a processes for generating a document including translated text is provided with reference to FIGS. 2 and 6-9. Further detail regarding a process for training a machine learning model is provided with reference to FIG. 10.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between media processing apparatus 105, database 125, and the user device.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in media processing apparatus 105. According to some aspects, database 125 is external to media processing apparatus 105 and communicates with media processing apparatus 105 via cloud 120.

According to some aspects, the user device is a personal computer, laptop computer, mainframe computer, palmtop computer, personal assistant, mobile device, or any other suitable processing apparatus. The user device may include software that displays user interface 110 provided by media processing apparatus 105. User interface 110 allows information to be communicated between the user and media processing apparatus 105.

According to some aspects, a user device user interface enables a user to interact with the user device. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

Input document 140 is an example of, or includes aspects of, the corresponding element described with reference to FIGS. 3 and 4. Output document 145 is an example of, or includes aspects of, the corresponding element described with reference to FIG. 3.

FIG. 2 shows an example of a method 200 for translating a document according to aspects of the present disclosure. Referring to FIG. 2, an example media processing system according to the present disclosure is used in a document translation context. In an example, a user provides a PDF file including a picture of an erupting volcano and the English words “Ring of Fire” to the media processing system, along with an instruction to generate the English words into Hindi. The media processing system uses a language generation model to generate a translation of the words “Ring of Fire” into an equivalent Hindi idiom given the context of the image of the erupting volcano. The media processing system then generates a new PDF file including the image of the erupting volcano and the Hindi translation in a style and position corresponding to the style and position of the English words “Ring of Fire” in the original document.

At operation 205, the system provides a document. In some cases, the operations of this step refer to, or may be performed by, a user as described with reference to FIG. 1. For example, the user provides the document to the media processing system (such as the media processing system 100 described with reference to FIG. 1) using a user interface (such as the user interface 110 described with reference to FIG. 1) provided on a user device (such as the user device 130 described with reference to FIG. 1) by the media processing system.

At operation 210, the system identifies contextual information. In some cases, the operations of this step refer to, or may be performed by, a media processing system as described with reference to FIGS. 1 and 3. In an example, the media processing system identifies a contextual element of the document as described with reference to FIGS. 1, 3-4, and 6. In the example of FIG. 2, the media processing system identifies a metadata caption describing the image of the erupting volcano included in the document as a context element.

At operation 215, the system translates the document based on the contextual information. In some cases, the operations of this step refer to, or may be performed by, a media processing apparatus as described with reference to FIGS. 1, 3, 11, and 12. In an example, the media processing system generates a translation of the text “Ring of Fire” based on the metadata caption using a language generation model, and generates a translated document including the translated text as described with reference to FIG. 3. The media processing system provides the translated document to the user via the user device.

FIG. 3 shows an example of a media processing system 300 for generating a document including translated text 360 according to aspects of the present disclosure. The example shown includes media processing system 300, input document 330, prompt 350, and output document 355. In one aspect, media processing system 300 includes media processing apparatus 305. In one aspect, media processing apparatus 305 includes user interface 310, prompt generation component 315, language generation model 320, and document generation component 325.

In one aspect, input document 330 includes text element 335 and context element 345. In one aspect, text element 335 includes source text 340. In one aspect, output document 355 includes translated text 360.

Referring to FIG. 3, according to some aspects, user interface 310 receives an input document (e.g., input document 330). The input document includes a context element (e.g., context element 345) and a text element (e.g., text element 335) including text in a source language (e.g., source text 340). User interface 310 provides the input document to prompt generation component 315 and document generation component 325.

The context element may include an image and/or metadata. The metadata may include an embedded image caption, a mood of the document, a style of the document, a segment identification of the document, a title of the document, a topic of the document, or a combination thereof. The metadata may be associated with the document as a whole or with an individual portion of the document, such as a page of the document. The context element may include an image. For example, input document 330 includes an image of a bow and arrow (context element 345) and source text “bow” (source text 340) provided in English (the source language).

The input document may further include a layout, and the text element may be displayed in the input document at a position according to the layout. In an example, text element 335 is displayed in input document 330 in a position relative to other elements of input document 330.

A user may provide a text selection input to user interface 310 to select the source included in the text element. For example, the user may click on an area of user interface 310 corresponding to the text element, and user interface 310 identifies the click as a selection of the source text.

User interface 310 may receive a language selection input including a selection of one or more languages, such as a first target language, a second target language, etc. In an example, the user types the one or more language selections into a language selection element of user interface 310, or selects the one or more languages from the language selection element (such as a drop down menu). In some embodiments, the user provides a source language selection of the source language.

Prompt generation component 315 generates a prompt (e.g., prompt 350) based on the context element and the text element. In some embodiments, the prompt includes a sequence of tokens representing instructions for language generation model 320 to translate the text into a target language. The context element is used as context to translate the text into the target language.

Prompt generation component 315 extracts the context element from the input document. In some embodiments, where the context element includes an image without an embedded image caption, prompt generation component 315 generates an image caption based on the image (e.g., using a machine learning model trained to generate an image caption of an image, such as a convolutional neural network (CNN) or a vision transformer (ViT)) and generates the prompt based on the image caption.

Prompt generation component 315 generates the prompt by filling a template with the context element, or the image caption generated based on the context element, the source text, and information associated with one or more of the context element, the image caption generated based on the context element, and the source text, such as a page number. An example template is “Translate <the source text> from page [ ] into <the target language> based on the following context for the translation. The document has [ ] mood. The document includes an image of <image caption> on page [ ]. Use a [ ] tone of voice.” A corresponding example prompt is “Translate ‘bow’ from page 1 into Hindi based on the following context for the translation. The document has an adventurous mood. The document includes an image of a bow and arrow on page 1. Use a formal tone of voice.” According to some aspects, text from each text element is associated with one prompt, and the prompt generation component associates the text element with the prompt. The template and prompt may be generated based on the user identification of the source language of the input document. In some embodiments, the prompt includes a sequence of tokens representing the instructions.

Prompt generation component 315 may generate the prompt based on an additional text element of the input document, where the text element is included in a first page of the input document and the additional text element is included in a second page of the input document, and where the additional text element includes additional text in the source language. Prompt generation component 315 may generate an additional prompt based on the text element, where the additional prompt includes a sequence of tokens representing instructions for the language generation model to translate the text into an additional target language.

According to some aspects, prompt generation component 315 generates a first prompt based on the text and the first target language, where the first prompt includes a first sequence of tokens representing instructions for the language generation model to translate the text into the first target language. In some examples, prompt generation component 315 generates a second prompt based on the text and the second target language, where the second prompt includes a second sequence of tokens representing instructions for the language generation model 320 to translate the text into the second target language.

Language generation model 320 translates the source text into the target language based on the prompt. In an example, translated text 360 includes a Hindi translation of the English noun “bow” meaning a type of strung projectile weapon. In some examples, language generation model 320 translates the additional text into the target language based on the prompt. In some examples, language generation model 320 translates the source text into the additional target language based on the prompt.

Document generation component 325 generates an output document (e.g., output document 355) including the context element and the text element with the translated text. The output document 355 may include a layout, and the text element may be displayed in the output document at a position according to the layout. Document generation component 325 may identify a style of the text element, where the text may be displayed in the output document according to the style of the text element. For example, output document 355 includes a Hindi translation of the English word “bow” displayed with a same stylization in text element 335, and text element 335 and context element 345 are displayed in output document 355 according to a same layout as in input document 330. In some embodiments, document generation component 325 links an output of language generation model 320 to a text element based on the association of the text element and the prompt that was used to generate the output. In some embodiments, document generation component 325 expands the text field to allow the translated text to fit in the text field.

Document generation component 325 may generate the output document including the additional text element with the additional translated text. For example, output document 355 further includes additional source text from input document 330 (such as “Made to Last”, “Classic Bow Company”, and “SINCE 1121”) translated into Hindi in corresponding additional text elements. Document generation component 325 may generate an additional output document including the context element and the text element with the source text translated into the additional target language.

Media processing system 300 is an example of, or includes aspects of, the corresponding element described with reference to FIG. 1. Media processing apparatus 305 is an example of, or includes aspects of, the corresponding element described with reference to FIGS. 1, 11, and 12. User interface 310 is an example of, or includes aspects of, the corresponding element described with reference to FIGS. 1 and 4. Language generation model 320 is an example of, or includes aspects of, the corresponding element described with reference to FIGS. 1 and 12.

According to some aspects, user interface 310, prompt generation component 315, language generation model 320, document generation component 325, or a combination thereof comprise processor-executable instructions stored in a memory unit of media processing apparatus 305 (e.g., the memory unit 1210 described with reference to FIG. 12). According to some aspects, user interface 310, prompt generation component 315, language generation model 320, document generation component 325, or a combination thereof comprise one or more hardware circuits included in media processing apparatus 305. According to some aspects, user interface 310, prompt generation component 315, language generation model 320, document generation component 325, or a combination thereof comprise firmware of media processing apparatus 305.

Input document 330 is an example of, or includes aspects of, the corresponding element described with reference to FIGS. 1 and 4. Context element 345 is an example of, or includes aspects of, the corresponding element described with reference to FIG. 4. Output document 355 is an example of, or includes aspects of, the corresponding element described with reference to FIG. 1.

FIG. 4 shows an example of a user interface 400 for generating a document including translated text according to aspects of the present disclosure. The example shown includes user interface 400 and input document 455. In one aspect, user interface 400 includes translation control component 405 and document display component 450. In one aspect, translation control component 405 includes language selection component 410, tone selection component 425, page selection component 430, and translate button 445. In one aspect, language selection component 410 includes first selected language 415 and second selected language 420. In one aspect, page selection component 430 includes first selected page 435 and second selected page 440.

In one aspect, input document 455 includes first page 460 and second page 480. In one aspect, first page 460 includes first text element 465 and context element 475. In one aspect, first text element 465 includes first text 470. In one aspect, second page 480 includes second text element 485. In one aspect, second text element 485 includes second text 490.

Referring to FIG. 4, according to some aspects, user interface 400 allows a user, such as the user 135 as described with reference to FIG. 1, to select text from multiple text elements (e.g., first text 470 from first text element 465 and second text 490 from second text element 485) from multiple pages of a document (e.g., first page 460 and second page 480 of input document 455) for translation by checking page selection boxes via page selection component 430. A representation of the input document is displayed by document display component 450. Pages of the original document may become available for display in response to a selection of corresponding pages in page selection component 430 (for example, first selected page 435 and second selected page 440 causes document display component 450 to display first page 460 and second page 480), and the user may select individual text elements from the displayed pages. The user may also select one or more context elements of the input document (e.g., context element 475).

User interface 400 also allows the user to select one or more target languages (such as first selected language 415, Punjabi, and second selected language 420, Telugu) for the selected text element(s) to be translated into (for example, by typing the language(s) into language selection component 410, or selecting the languages from a list of languages displayed by language selection component 410). In the example of FIG. 4, a user has also selected Hindi, Kannada, Malayalam, Gujarati, and Tamil as target languages.

User interface 400 also allows the user to select a tone of voice for the translation using tone selection component 425. In the example of FIG. 4, a user has selected a “formal” tone for the translation.

According to some aspects, the input document may include a set of pages. User interface 400 may receive a user input indicating a first target language, a second target language, and a subset of the set of pages. The source text may be included in a set of text elements included in the indicated subset of the set of pages, and the user input may indicates the set of text elements.

In an example, user interface 400 may receive a user input indicating which text elements of the input document are to be translated, where the indicated text elements are selectively translated based on the user input. In some aspects, the text and the context element are each included in a same page of the indicated subset of the set of pages.

In response to a user input provided to translate button 445, a prompt generation component (such as the prompt generation component 315 described with reference to FIG. 3) generates a prompt for each selected text element and each selected language based on the selected language(s), the tone of voice selection, a context element, or a combination thereof as described with reference to FIG. 3. A language generation model (such as the language generation model 320 described with reference to FIG. 3) translates text from each of the indicated subset of the set of pages into the first target language and the second target language. In some examples, the language generation model translates the text into the first target language and the second target language based on a first prompt and a second prompt, respectively.

A document generation component (such as the document generation component 325 described with reference to FIG. 3) generates a first output document and a second output document, where the first output document includes the translated text in the first target language in the indicated subset of the set of pages, and the second output document includes the translated text in the second target language in the indicated subset of the set of pages. In the example of FIG. 4, for example, the document generation component generates a first output document including each text element that is translated into Punjabi, a second output document including each text element that is translated into Telugu, and so on.

User interface 400 is an example of, or includes aspects of, the corresponding element described with reference to FIGS. 1 and 3. Input document 455 is an example of, or includes aspects of, the corresponding element described with reference to FIGS. 1 and 3. Context element 475 is an example of, or includes aspects of, the corresponding element described with reference to FIG. 3.

FIG. 5 shows an example of a transformer 500 according to aspects of the present disclosure. The example shown includes encoder 505, decoder 520, input 540, input embedding 545, input positional encoding 550, previous output 555, previous output embedding 560, previous output positional encoding 565, and output 570. According to some aspects, transformer 500 comprises architectural elements of the language generation model described with reference to FIGS. 1, 3, and 12.

According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Encoder 505 includes multi-head self-attention sublayer 510 and feed-forward network sublayer 515. Decoder 520 includes first multi-head self-attention sublayer 525, second multi-head self-attention sublayer 530, and feed-forward network sublayer 535.

Encoder 505 is configured to map input 540 (for example, an instruction) to a sequence of continuous representations that are fed into decoder 520. Decoder 520 generates output 570 (e.g., a prediction of an output sequence of words or tokens) based on the output of encoder 505 and previous output 555 (e.g., a previously predicted output sequence), which allows for the use of autoregression.

For example, encoder 505 parses input 540 into tokens and vectorizes the parsed tokens to obtain input embedding 545, and adds input positional encoding 550 (e.g., positional encoding vectors for input 540 of a same dimension as input embedding 545) to input embedding 545. Input positional encoding 550 includes information about relative positions of words or tokens in input 540.

Encoder 505 comprises one or more encoding layers that generate contextualized token representations, where each representation corresponds to a token that combines information from other input tokens via self-attention mechanism. Each encoding layer of encoder 505 comprises a multi-head self-attention sublayer (e.g., multi-head self-attention sublayer 510). The multi-head self-attention sublayer implements a multi-head self-attention mechanism that receives different linearly projected versions of queries, keys, and values to produce outputs in parallel. Each encoding layer of encoder 505 also includes a fully connected feed-forward network sublayer (e.g., feed-forward network sublayer 515) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

Each layer employs different weight parameters (W₁, W₂) and different bias parameters (b₁, b₂) to apply a same linear transformation to each word or token in input 540.

Each sublayer of encoder 505 is followed by a normalization layer that normalizes a sum computed between a sublayer input x and an output sublayer (x) generated by the sublayer:

$$layernorm ( x + sublayer ( x ) ) \qquad ( 2 )$$

Encoder 505 is bidirectional because encoder 505 attends to each word or token in input 540 regardless of a position of the word or token in input 540.

Decoder 520 comprises one or more decoding layers (e.g., six decoding layers). Each decoding layer comprises three sublayers including a first multi-head self-attention sublayer (e.g., first multi-head self-attention sublayer 525), a second multi-head self-attention sublayer (e.g., second multi-head self-attention sublayer 530), and a feed-forward network sublayer (e.g., feed-forward network sublayer 535). Each sublayer of decoder 520 is followed by a normalization layer that normalizes a sum computed between a sublayer input x and an output sublayer(x) generated by the sublayer.

Decoder 520 generates previous output embedding 560 of previous output 555 and adds previous output positional encoding 565 (e.g., position information for words or tokens in previous output 555) to previous output embedding 560. Each first multi-head self-attention sublayer receives the combination of previous output embedding 560 and previous output positional encoding 565 and applies a multi-head self-attention mechanism to the combination. For each word in an input sequence, each first multi-head self-attention sublayer of decoder 520 attends only to words preceding the word in the sequence, and so a prediction of transformer 500 for a word at a particular position only depends on known outputs for a word that came before the word in the sequence. In some cases, each first multi-head self-attention sublayer implements multiple single-attention functions in parallel by introducing a mask over values produced by the scaled multiplication of matrices Q and K by suppressing matrix values that would otherwise correspond to disallowed connections.

Each second multi-head self-attention sublayer implements a multi-head self-attention mechanism similar to the multi-head self-attention mechanism implemented in each multi-head self-attention sublayer of encoder 505 by receiving a query Q from a previous sublayer of decoder 520 and a key K and a value V from the output of encoder 505, allowing decoder 520 to attend to each word in the input 540.

Each feed-forward network sublayer implements a fully connected feed-forward network similar to feed-forward network sublayer 515. The feed-forward network sublayers are followed by a linear transformation and a softmax to generate a prediction of output 570.

### Document Generation

FIG. 6 shows an example of a method 600 for generating a document including translated text according to aspects of the present disclosure. Referring to FIG. 6, aspects of the present invention leverage advanced capabilities of a language generation model (e.g., a large language model) to generate a translation of document text from a first language into a second language based on a context of the document. For example, a document may include the text “bow” and a picture of a bow and arrow. The language generation model may be instructed to translate the word bow given the context of the picture of the bow and arrow. Therefore, the language generation model will interpret and translate the word “bow” as the noun “bow” that refers to a weapon, rather than a different noun or verb “bow”.

Accordingly, aspects of the present disclosure provide translations having an increased linguistic accuracy and contextual appropriateness over translations provided by conventional translation models, making the translation more relevant and tailored to specific needs and improving communication across languages. Furthermore, the language generation model can adapt to various domains and styles, enhancing a versality of the language generation model.

At operation 605, the system obtains an input document including a context element and a text element, where the text element includes text in a source language. In some cases, the operations of this step refer to, or may be performed by, a media processing apparatus as described with reference to FIGS. 1, 3, 11, and 12. In an example, a user interface of the media processing apparatus obtains the document from a user as described with reference to FIGS. 1 and 3.

At operation 610, the system generates a prompt based on the context element and the text element, where the prompt includes a sequence of tokens representing instructions for a language generation model to translate the text into a target language. In some cases, the operations of this step refer to, or may be performed by, a prompt generation component as described with reference to FIG. 3. For example, the prompt generation component generates the prompt as described with reference to FIG. 3.

At operation 615, the system translates, using the language generation model, the text into the target language based on the prompt. In some cases, the operations of this step refer to, or may be performed by, a language generation model as described with reference to FIGS. 1, 3, and 12. For example, the language generation model translates the text as described with reference to FIG. 3.

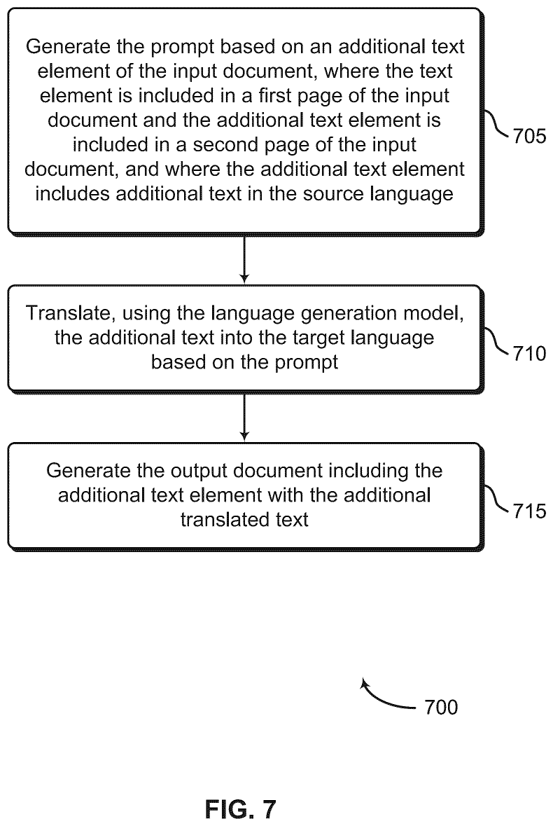

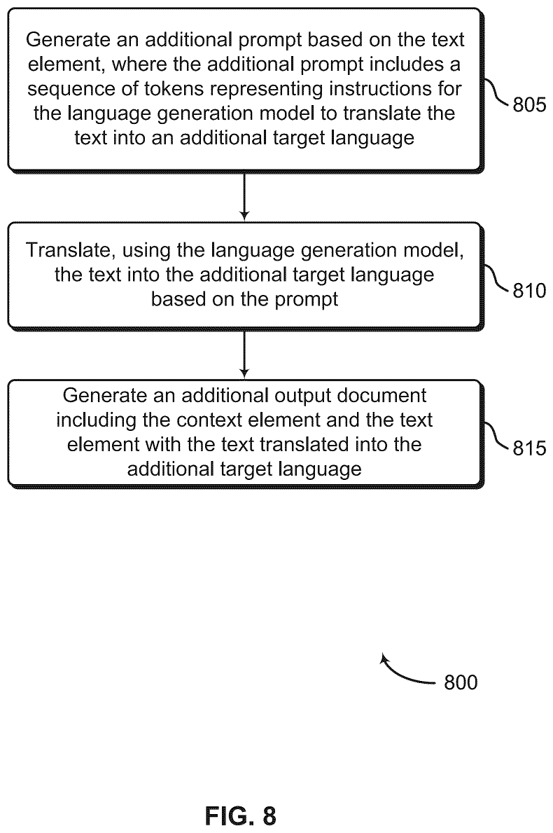

At operation 620, the system generates an output document including the context element and the text element with the translated text. In some cases, the operations of this step refer to, or may be performed by, a document generation component as described with reference to FIG. 3. For example, the document generation component generates the output document as described with reference to FIG. 3. In some embodiments, the document generation component generates a document including additional translated text as described with reference to FIGS. 3 and 7. In some embodiments, the document generation component generates an additional document as described with reference to FIGS. 3 and 8.

FIG. 7 shows an example of a method 700 for generating a document including additional translated text according to aspects of the present disclosure. At operation 705, the system generates the prompt based on an additional text element of the input document, where the text element is included in a first page of the input document and the additional text element is included in a second page of the input document, and where the additional text element includes additional text in the source language. In some cases, the operations of this step refer to, or may be performed by, a prompt generation component as described with reference to FIG. 3.

At operation 710, the system translates, using the language generation model, the additional text into the target language based on the prompt. In some cases, the operations of this step refer to, or may be performed by, a language generation model as described with reference to FIGS. 1, 3, and 12.

At operation 715, the system generates the output document including the additional text element with the additional translated text. In some cases, the operations of this step refer to, or may be performed by, a document generation component as described with reference to FIG. 3.

FIG. 8 shows an example of a method 800 for generating an additional document including text translated in an additional language according to aspects of the present disclosure. At operation 805, the system generates an additional prompt based on the text element, where the additional prompt includes a sequence of tokens representing instructions for the language generation model to translate the text into an additional target language. In some cases, the operations of this step refer to, or may be performed by, a prompt generation component as described with reference to FIG. 3.

At operation 810, the system translates, using the language generation model, the text into the additional target language based on the prompt. In some cases, the operations of this step refer to, or may be performed by, a language generation model as described with reference to FIGS. 1, 3, and 12.

At operation 815, the system generates an additional output document including the context element and the text element with the text translated into the additional target language. In some cases, the operations of this step refer to, or may be performed by, a document generation component as described with reference to FIG. 3.

Accordingly, a method for media processing is described. One or more aspects of the method include obtaining an input document including a context element and a text element, wherein the text element includes text in a source language; generating a prompt based on the context element and the text element, wherein the prompt comprises a sequence of tokens representing instructions for a language generation model to translate the text into a target language; translating, using the language generation model, the text into the target language based on the prompt; and generating an output document including the context element and the text element with the translated text. In some aspects, the output document further includes a layout and the text element is displayed in the output document at a position according to the layout.

Some examples of the method further include identifying a style of the text element, wherein the text is displayed in the output document according to the style of the text element. Some examples of the method further include extracting the context element from the input document. In some aspects, the context element comprises metadata. In some aspects, the metadata comprises an image caption, a mood, a style, a segment, a title, or a topic of the input document. In some aspects, the context element comprises an image.

Some examples of the method further include generating a caption for the image, wherein the prompt is generated based on the caption for the image. In some aspects, the context element is used as context to translate the text into the target language. Some examples of the method further include receiving a user input indicating which text elements of the input document are to be translated, wherein the indicated text elements are selectively translated based on the user input.

Some examples of the method further include generating the prompt based on an additional text element of the input document, wherein the text element is included in a first page of the input document and the additional text element is included in a second page of the input document, and wherein the additional text element includes additional text in the source language. Some examples further include translating, using the language generation model, the additional text into the target language based on the prompt. Some examples further include generating the output document including the additional text element with the additional translated text.

Some examples of the method further include generating an additional prompt based on the text element, wherein the additional prompt comprises a sequence of tokens representing instructions for the language generation model to translate the text into an additional target language. Some examples further include translating, using the language generation model, the text into the additional target language based on the prompt. Some examples further include generating an additional output document including the context element and the text element with the text translated into the additional target language.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Generating Multiple Documents

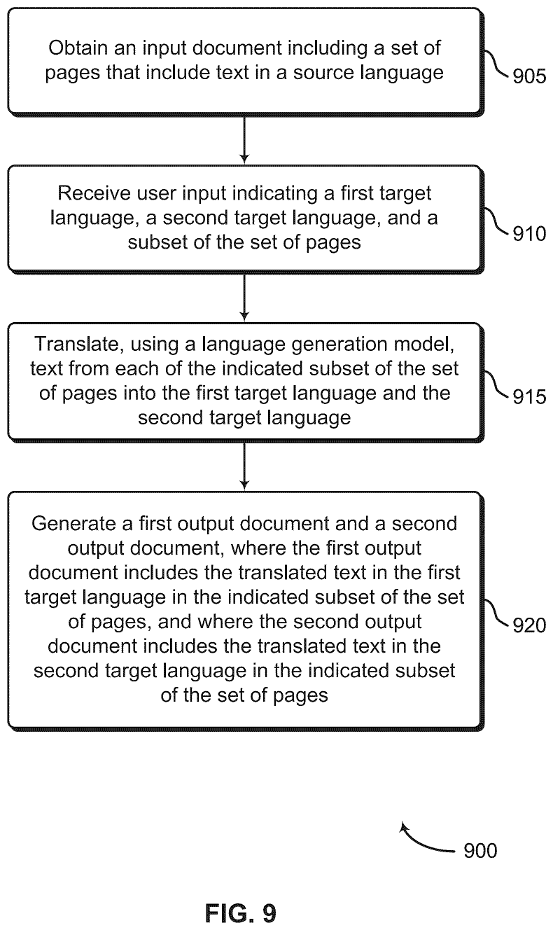

FIG. 9 shows an example of a method 900 for generating multiple documents in multiple languages according to aspects of the present disclosure. Referring to FIG. 9, aspects of the present disclosure provide for a selection of multiple portions of text in a document from different pages of the document, and also provide for a selection of multiple target languages to translate the selected text into. For example, a user may select one or more text elements of the document across one or more pages of the document for translation and may therefore leave out other text that might not need to be translated, such as names, addresses, dates, URLs, emails, etc. According to some aspects, a user may choose from multiple languages for the translation, allowing for single-click multilingual translation.

At operation 905, the system obtains an input document including a set of pages that include text in a source language. In some cases, the operations of this step refer to, or may be performed by, a media processing apparatus as described with reference to FIGS. 1, 3, 11, and 12. In an example, a user interface of the media processing apparatus obtains the document from a user as described with reference to FIGS. 1 and 3-4.

At operation 910, the system receives user input indicating a first target language, a second target language, and a subset of the set of pages. In some cases, the operations of this step refer to, or may be performed by, a user interface as described with reference to FIGS. 1, 3, and 4. For example, the user interface receives the user input as described with reference to FIGS. 3 and 4.

At operation 915, the system translates, using a language generation model, text from each of the indicated subset of the set of pages into the first target language and the second target language. In some cases, the operations of this step refer to, or may be performed by, a language generation model as described with reference to FIGS. 1, 3, and 12. In an example, the language generation model translates the text as described with reference to FIGS. 3 and 4.

At operation 920, the system generates a first output document and a second output document, where the first output document includes the translated text in the first target language in the indicated subset of the set of pages, and where the second output document includes the translated text in the second target language in the indicated subset of the set of pages. In some cases, the operations of this step refer to, or may be performed by, a document generation component as described with reference to FIG. 3. In an example, the document generation component generates the first output document and the second output document as described with reference to FIGS. 3 and 4.

Accordingly, a method for media processing is described. One or more aspects of the method include obtaining an input document comprising a plurality of pages that include text in a source language; receiving user input indicating a first target language, a second target language, and a subset of the plurality of pages; translating, using a language generation model, text from each of the indicated subset of the plurality of pages into the first target language and the second target language; and generating a first output document and a second output document, wherein the first output document includes the translated text in the first target language in the indicated subset of the plurality of pages, and wherein the second output document includes the translated text in the second target language in the indicated subset of the plurality of pages. In some aspects, the text is included in a plurality of text elements included in the indicated subset of the plurality of pages, and the user input indicates the plurality of text elements.

Some examples of the method further include generating a first prompt based on the text and the first target language, wherein the first prompt comprises a first sequence of tokens representing instructions for the language generation model to translate the text into the first target language. Some examples further include generating a second prompt based on the text and the second target language, wherein the second prompt comprises a second sequence of tokens representing instructions for the language generation model to translate the text into the second target language. Some examples further include translating the text into the first target language and the second target language based on the first prompt and the second prompt, respectively.

Some examples of the method further include identifying a context element included in the input document, wherein the text is translated into at least one of the first target language and the second target language based on the context element. In some aspects, the text and the context element are each included in a same page of the indicated subset of the plurality of pages.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 10 shows an example of a flow diagram depicting an algorithm as a step-by-step procedure 1000 for training a machine learning model according to aspects of the present disclosure. In some embodiments, the procedure 1000 describes an operation of the training component 1225 described for configuring the language generation model 1215 as described with reference to FIG. 12. The procedure 1000 provides one or more examples of generating training data, use of the training data to train a machine learning model, and use of the trained machine learning model to perform a task.

To begin in this example, a machine learning system collects training data (block 1002) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1004) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1006). Initialization of the machine learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine learning model (i.e., predictions) and target values (e.g., as expressed by the training data) to be used to train the machine learning model. Additionally, an optimization algorithm is selected (1012) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1018) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1020), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine learning model using the training data (block 1018) in this example.

If the stopping criterion is met (“yes” from decision block 1020), the trained machine learning model is then utilized to generate an output based on subsequent data (block 1022). The trained machine learning model, for instance, is trained to perform a task as described above and therefore once trained is configured to perform that task based on subsequent data received as an input and processed by the machine learning model.

### Media Processing Apparatus

FIG. 11 shows an example of a computing device 1100 according to aspects of the present disclosure. Computing device 1100 is an example of, or includes aspects of, the media processing apparatus described with reference to FIGS. 1, 3, and 12. In one aspect, computing device 1100 includes processor(s) 1105, memory subsystem 1110, communication interface 1115, I/O interface 1120, user interface component(s) 1125, and channel 1130. In some embodiments, computing device 1100 includes one or more processors 1105 that can execute instructions stored in memory subsystem 1110 to perform document generation.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

FIG. 12 shows an example of a media processing apparatus 1200 according to aspects of the present disclosure. Media processing apparatus 1200 is an example of, or includes aspects of, the corresponding element described with reference to FIGS. 1, 3, and 11. In some embodiments, media processing apparatus 1200 includes processor unit 1205, memory unit 1210, language generation model 1215, I/O module 1220, and training component 1225. Training component 1225 updates parameters of the language generation model 1215 stored in memory unit 1210. In some examples, the training component 1225 is located outside the media processing apparatus 1200.

Processor unit 1205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1205 is configured to operate a memory array using a memory controller. In other cases, a memory controller is integrated into processor unit 1205. In some cases, processor unit 1205 is configured to execute computer-readable instructions stored in memory unit 1210 to perform various functions. In some aspects, processor unit 1205 includes special purpose components for modem processing, baseband processing, digital signal processing, or transmission processing. According to some aspects, processor unit 1205 comprises one or more processors 1105 described with reference to FIG. 11.

Memory unit 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1205 to perform various functions described herein.

In some cases, memory unit 1210 includes a basic input/output system (BIOS) that controls basic hardware or software operations, such as an interaction with peripheral components or devices. In some cases, memory unit 1210 includes a memory controller that operates memory cells of memory unit 1210. For example, the memory controller may include a row decoder, column decoder, or both. In some cases, memory cells within memory unit 1210 store information in the form of a logical state. According to some aspects, memory unit 1210 is an example of the memory subsystem 1110 described with reference to FIG. 11.

According to some aspects, media processing apparatus 1200 uses one or more processors of processor unit 1205 to execute instructions stored in memory unit 1210 to perform functions described herein. For example, the media processing apparatus 1200 may perform operations comprising obtaining an input document including a context element and a text element, wherein the text element includes text in a source language; generating a prompt based on the context element and the text element, wherein the prompt comprises a sequence of tokens representing instructions for a language generation model to translate the text into a target language; translating, using the language generation model, the text into the target language based on the prompt; and generating an output document including the context element and the text element with the translated text.

The memory unit 1210 may include a language generation model 1215 trained to generate a text output based on a prompt. For example, after training, the language generation model 1215 may perform inferencing operations as described with reference to FIGS. 3-9 to translate the text into the target language based on the prompt. Language generation model 1215 is an example of, or includes aspects of, the corresponding element described with reference to FIGS. 1 and 3.

In some embodiments, the language generation model 1215 is an artificial neural network (ANN) such as the transformer described with reference to FIG. 5. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the language generation model 1215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1225 may train the language generation model 1215. For example, parameters of the language generation model 1215 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 10). The goal of the training process may be to find optimal values for the parameters that allow the language generation model 1215 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the language generation model 1215 can be used to make predictions on new, unseen data (i.e., during inference).

I/O module 1220 receives inputs from and transmits outputs of the media processing apparatus 1200 to other devices or users. For example, I/O module 1220 receives inputs for the language generation model 1215 and transmits outputs of the language generation model 1215. According to some aspects, I/O module 1220 is an example of the I/O interface 1120 described with reference to FIG. 11.

According to some aspects, training component 1225 comprises executable code (e.g., software) stored in memory unit 1210, firmware, one or more hardware circuits, or a combination thereof.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for media processing, comprising:
obtaining an input document including a context element and a text element, wherein the text element includes text in a source language;
generating a prompt based on the context element and the text element, wherein the prompt comprises a sequence of tokens representing instructions for a language generation model to translate the text into a target language;
translating, using the language generation model, the text into the target language based on the prompt; and
generating an output document including the context element and the text element with the translated text.

2. The method of claim 1, wherein:
the output document further includes a layout and the text element is displayed in the output document at a position according to the layout.

3. The method of claim 1, further comprising:
identifying a style of the text element, wherein the text is displayed in the output document according to the style of the text element.

4. The method of claim 1, further comprising:
extracting the context element from the input document.

5. The method of claim 1, wherein:
the context element comprises metadata.

6. The method of claim 5, wherein:
the metadata comprises an image caption, a mood, a style, a segment, a title, or a topic of the input document.

7. The method of claim 1, wherein:
the context element comprises an image.

8. The method of claim 7, further comprising:
generating a caption for the image, wherein the prompt is generated based on the caption for the image.

9. The method of claim 1, wherein:
the context element is used as context to translate the text into the target language.

10. The method of claim 1, further comprising:
receiving a user input indicating which text elements of the input document are to be translated, wherein the indicated text elements are selectively translated based on the user input.

11. The method of claim 1, further comprising:
generating the prompt based on an additional text element of the input document, wherein the text element is included in a first page of the input document and the additional text element is included in a second page of the input document, and wherein the additional text element includes additional text in the source language;
translating, using the language generation model, the additional text into the target language based on the prompt; and
generating the output document including the additional text element with the additional translated text.

12. The method of claim 1, further comprising:
generating an additional prompt based on the text element, wherein the additional prompt comprises a sequence of tokens representing instructions for the language generation model to translate the text into an additional target language;
translating, using the language generation model, the text into the additional target language based on the prompt; and
generating an additional output document including the context element and the text element with the text translated into the additional target language.

13. A non-transitory computer readable medium storing code for image processing, the code comprising instructions that, when executed by at least one processor, cause the at least one processor to perform operations comprising:
obtaining an input document comprising a plurality of pages that include text in a source language;
receiving user input indicating a first target language, a second target language, and a subset of the plurality of pages;
translating, using a language generation model, text from each of the indicated subset of the plurality of pages into the first target language and the second target language; and
generating a first output document and a second output document, wherein the first output document includes the translated text in the first target language in the indicated subset of the plurality of pages, and wherein the second output document includes the translated text in the second target language in the indicated subset of the plurality of pages.

14. The non-transitory computer readable medium of claim 13, wherein:
the text is included in a plurality of text elements included in the indicated subset of the plurality of pages, and the user input indicates the plurality of text elements.

15. The non-transitory computer readable medium of claim 13, the code further comprising instructions that, when executed by the at least one processor, cause the at least one processor to perform operations comprising:
generating a first prompt based on the text and the first target language, wherein the first prompt comprises a first sequence of tokens representing instructions for the language generation model to translate the text into the first target language;
generating a second prompt based on the text and the second target language, wherein the second prompt comprises a second sequence of tokens representing instructions for the language generation model to translate the text into the second target language; and
translating the text into the first target language and the second target language based on the first prompt and the second prompt, respectively.

16. The non-transitory computer readable medium of claim 13, the code further comprising instructions that, when executed by the at least one processor, cause the at least one processor to perform operations comprising:
identifying a context element included in the input document, wherein the text is translated into at least one of the first target language and the second target language based on the context element.

17. The non-transitory computer readable medium of claim 16, wherein:
the text and the context element are each included in a same page of the indicated subset of the plurality of pages.

18. A system comprising:
a memory component; and
a processing device coupled to the memory component, the processing device configured to perform operations comprising:
obtaining an input document including a context element and a text element, wherein the text element includes text in a source language;
generating a prompt based on the context element and the text element, wherein the prompt comprises a sequence of tokens representing instructions for a language generation model to translate the text into a target language;
translating, using the language generation model, the text into the target language based on the prompt; and
generating an output document including the context element and the text element with the translated text.

19. The system of claim 18, the processing device being further configured to perform operations comprising:
generating the prompt based on an additional text element of the input document, wherein the text element is included in a first page of the input document and the additional text element is included in a second page of the input document, and wherein the additional text element includes additional text in the source language;
translating, using the language generation model, the additional text into the target language based on the prompt; and
generating the output document including the additional text element with the additional translated text.

20. The system of claim 18, the processing device being further configured to perform operations comprising:
generating an additional prompt based on the text element, wherein the additional prompt comprises a sequence of tokens representing instructions for the language generation model to translate the text into an additional target language;
translating, using the language generation model, the text into the additional target language based on the prompt; and
generating an additional output document including the context element and the text element with the text translated into the additional target language.
